(19) United States
(12) Patent Application Publication
(10) Pub. No.: US 2005/0270032 A1
(43) Pub. Date: Dec. 8, 2005

(54) Malleable capacitive sensing device

(76) Inventor: Kenneth A. McQueeney, Los Gatos, CA (US)

Correspondence Address: MCDERMOTT WILL & EMERY LLP, 600 13th Street, N.W., Washington, DC, 20005-3096, US

(21) Appl. No.: 10/861,883

(22) Filed: Jun. 7, 2004

(51) Int. Cl. G06G 7/70

(52) U.S. Cl. 324/402

(57) ABSTRACT

A capacitive sensing device is provided including a flexible base sheet and a plurality of capacitive sensors arranged on an exterior surface of the flexible base sheet. Each capacitive sensor includes a top conductor layer, a middle dielectric layer, and a bottom conductive layer, the top conductor layer and bottom conductive layers having an electrical lead connected thereto.

### BACKGROUND

1. Field

This patent application relates to a malleable capacitive sensing device. The disclosed malleable capacitive sensing device is advantageously employed in the field of ignition testing of ignition coils and lends itself to ignition testing of, for example, hybrid ignition coils and coil-on plug ignition coils when placed in electric near fields proximate an ignition coil.

2. Description of Related Art

Ignition coils are commonly used in internal combustion engines to boost a low voltage supply voltage to the very high voltage level necessary to initiate and sustain a spark across a spark plug gap of a spark plug. The spark ignites a fuel-air mixture in an associated engine cylinder, causing increased pressure in the cylinder which produces movement of a piston within the cylinder. Historically, a single ignition coil was used in combination with a distributor to supply the high voltage needed by the spark plugs. The distributor was connected between the ignition coil and the spark plugs to sequentially distribute, using a rotor, the high voltage generated by the ignition coil to each of the spark plugs.

The ignition coil itself is, essentially, a transformer having a very large turn ratio, typically between 1:50 to 1:100, between the primary and secondary, which transforms the low voltage in a primary winding provided by the sudden opening of the primary current to a high voltage in a secondary winding. In older ignition systems, the ignition coil is connected to the center or coil terminal of a distributor cap by an insulated wire. High voltage from the ignition coil is distributed from the coil terminal to side or spark plug terminals of the distributor cap by means of a rotor. As the tip of the rotor spins in the cap past a series of contacts (one contact per cylinder), a high-voltage pulse from the coil arcs across the small gap between the rotor and the contact and continues down the spark-plug wire to the spark plug on the appropriate cylinder, thus distributing the spark to each spark plug terminal at a predetermined timing.

More recently, ignition systems have evolved to “distributorless” ignition systems having one coil per cylinder (e.g., conventional coil-on-plug (COP)) or one coil per cylinder pair (e.g., a direct ignition system (DIS) or Hybrid). Distributorless ignition systems, as the name implies, do not utilize distributor caps or rotors and, instead, incorporate an ignition coil over each plug (or plug pair) or an ignition coil near each plug (coil near plug or CNP)(or plug pair). The ignition coil generates the high voltage and supplies it only to the single spark plug (e.g., COP) or spark plug pair (e.g., DIS or Hybrid) with which it is associated. Coil-on-plug (COP) ignitions generally comprise a spark coil integrally mounted on spark plug, which protrudes into and is mounted in an engine cylinder and terminates in spark gap. The spark coil conducts transformed, high voltage direct current to the spark plug using internal connections. The coil receives low voltage direct current via a wiring harness that has a distal end coupled to a primary coil of the coil and a proximal end coupled to a battery.

Some distributorless ignition systems (e.g., hybrid) are configured so that at least one of the two plugs in the pair is buried or otherwise inaccessible (e.g., one or both plugs are COP), whereas other distributorless ignition systems (e.g., DIS) are configured so that both plugs in the pair are accessible. For example, in the hybrid ignition system, the ignition coil may be connected to one spark plug by a conventional ignition wire and to the other companion spark plug by means of a direct connection (e.g., a COP connection, such as a rigid extension or bus protruding from the bottom of the ignition coil to the spark plug). Thus configured, the DIS and hybrid ignitions simultaneously generate and output two different high voltage signals and associated electric near fields. As is commonly known, it is with these electric near fields that an appropriately configured sensor, such as but not limited to that shown in U.S. Pat. No. 6,396,277, the content of which is incorporated herein by reference, may be used to develop waveforms of the ignition cycle to aid in detection of and diagnosis of ignition system anomalies.

A single signal detector is often used to detect the signals on each spark plug. A technician first clips or places the signal detector adjacent the housing of one or more ignition coils in accord with the particular design of the signal detector and/or ignition coils. Upon each firing of the spark plug during engine operation, the ignition coil generates an electric near field having a voltage typically proportional to the voltage that the ignition coil delivers to the spark plug. The signal detector detects this electric near field and the resulting signal may be processed to extract the most relevant information to the technician.

A plethora of signal detectors/adapters/sensors are available to permit detection of ignition coil electric near fields, such as disclosed in U.S. patent application Ser. No. 10/825,211 filed Apr. 16, 2004 titled “HYBRID COP SAMPLING OF COMBINED (TANGLED) ELECTRIC FIELDS” by Kenneth MCQUEENEY (based on U.S. Provisional Patent Application No. 60/463,310 filed Apr. 17, 2003), U.S. patent application Ser. No. 10/804,230 filed Mar. 19, 2004 titled “DUAL CAPACITIVE-COUPLED SENSOR FOR HYBRID IGNITION” by Kenneth MCQUEENEY (based on U.S. Provisional Patent Application No. 60/456,223 filed Mar. 21, 2003), and U.S. patent application Ser. No. 10/772,396 titled “UNIVERSAL CAPACITIVE ADAPTER FOR ENGINE DIAGNOSTICS” by Kenneth MCQUEENEY et al. filed Feb. 6, 2004, each of the above applications being incorporated by reference in their entirety herein.

However, despite the advancements realized by present coil-on plug signal detection devices, there remains room for improvement, particularly in the fitting of signal detectors to a wide range of ignition coil types and ignition coil housings.

### SUMMARY

This disclosure relates to a malleable capacitive sensing device adaptable to permit ignition testing of ignition coils when placed in electric near fields proximate an ignition coil.

In one aspect, a capacitive sensing device is provided including a flexible base sheet and a plurality of capacitive sensors arranged on an exterior surface of the flexible base sheet. Each capacitive sensor includes a top conductor layer, a middle dielectric layer, and a bottom conductive layer, the top conductor layer and bottom conductive layers having an electrical lead connected thereto.

In another aspect, a diagnostic system for analyzing the operation of an internal combustion engine is provided and comprises a capacitive sensing device comprising a flexible base sheet and a plurality of capacitive sensors arranged on an exterior surface thereof, each capacitive sensor comprising a top conductor layer, a middle dielectric layer, and a bottom conductive layer, each of the top conductor layer and bottom conductive layer having an electrical lead connected thereto.

In yet another aspect, a method for detecting an electric near field present proximate an ignition coil housing is provided and comprises the steps of draping a capacitive sensing device comprising a flexible base sheet and a plurality of capacitive sensors arranged on a surface thereof over an ignition coil housing with the plurality of capacitive sensors disposed adjacent the ignition coil housing, securing at least some of the plurality of capacitive sensors adjacent the ignition coil housing, and outputting from at least some of the plurality of capacitive sensors a signal representative of an electric near field generated by the ignition coil in the ignition coil housing.

Other aspects and advantages of the present disclosure will become apparent to those skilled in this art from the following description of preferred aspects taken in conjunction with the accompanying drawings. As will be realized, the disclosed concepts are capable of other and different embodiments, and its details are capable of modifications in various obvious respects, all without departing from the spirit thereof. Accordingly, the drawings, disclosed aspects, and description are to be regarded as illustrative in nature, and not as restrictive.

### BRIEF DESCRIPTION OF THE DRAWINGS

FIGS. 1(a)-1(b) are front views of two aspects of a malleable capacitive sensing device in accord with the present concepts.

FIGS. 1(c)-1(d) are rear views of two aspects of a malleable capacitive sensing device in accord with the present concepts.

FIGS. 1(e)-1(f) are side views of two aspects of a malleable capacitive sensing device in accord with the present concepts.

FIG. 2(a) represents a malleable capacitive sensing device in accord with the present concepts disposed over an ignition coil housing.

FIG. 2(b) is a cross-sectional view of a malleable capacitive sensing device in accord with the present concepts taken along the cross-sectional line II-II in FIG. 1(a).

FIG. 2(c) is a side view representation of a switched capacitive element of a malleable capacitive sensing device in accord with the present concepts disposed adjacent an ignition coil housing.

FIG. 3 represents an equipment setup for a malleable capacitive sensing device in accord with the present concepts.

The figures referred to herein are examples provided and drawn for clarity of illustration and are not intended to be limiting in any way. The figures are not necessarily drawn to scale and are not necessarily inclusive of every feature or aspect of the objects or concepts featured therein. Elements having the same reference numerals refer to elements having similar structure and function.

### DETAILED DESCRIPTION

Ignition coils, such as COP ignition coils, receive a low input voltage at the primary winding and generate a high voltage output signal, which may be positive-going or negative-going. As each high voltage signal is generated, a corresponding electric near field is generated. For example, conventional COP plugs generate an electric near field substantially proportional to the high-voltage generated in the secondary winding of the COP ignition coil. By measuring these electric near fields, information about the operation of the ignition system may be gleaned. A single, adaptable capacitive sensing device is needed to sense electric near fields adjacent all ignition housing configurations (e.g., COP, Hybrid, DIS) and possibly even the spark plug lines of conventional ignition coils.

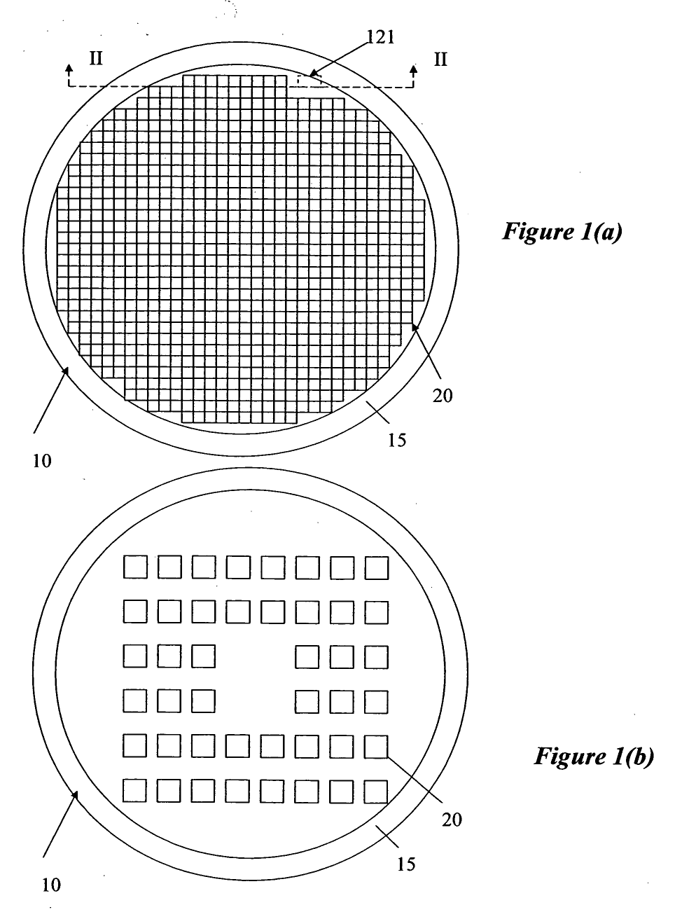

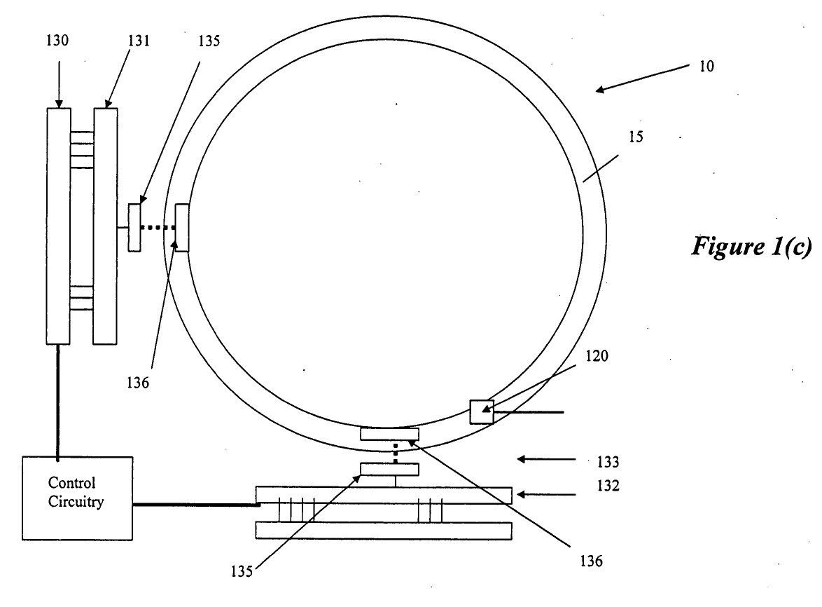

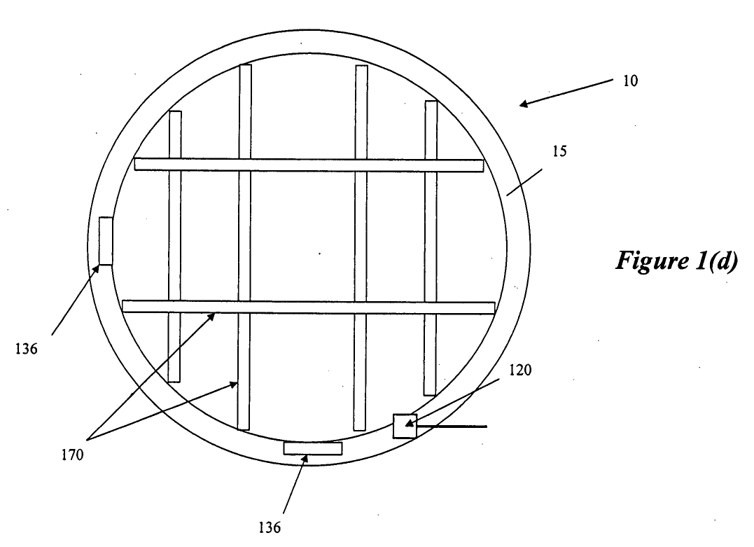

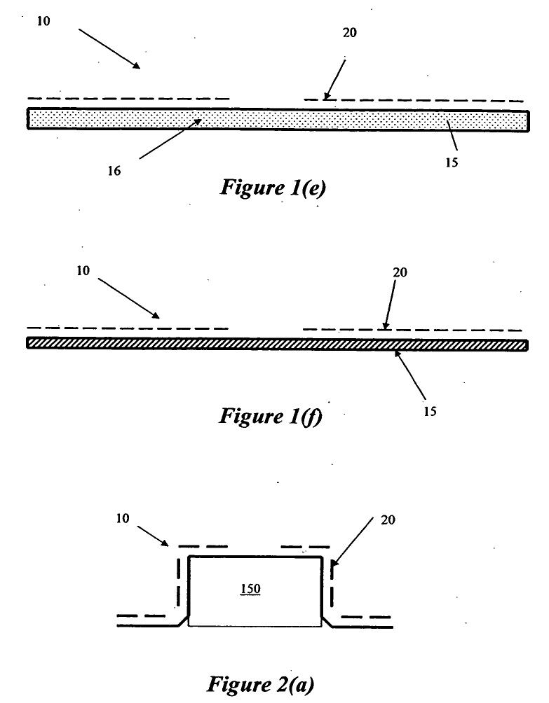

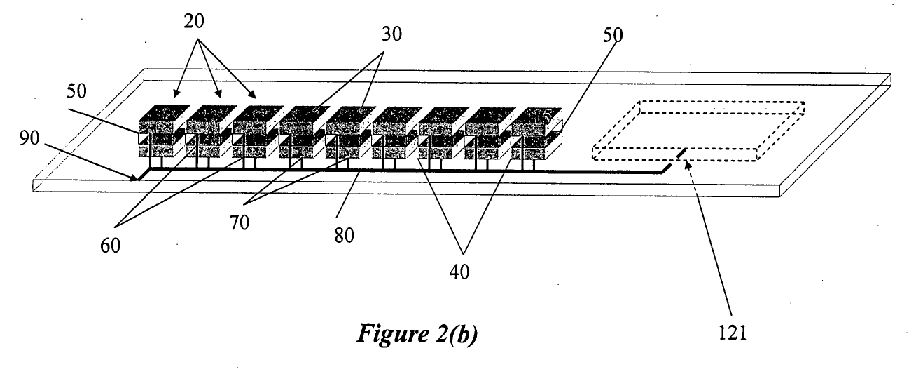

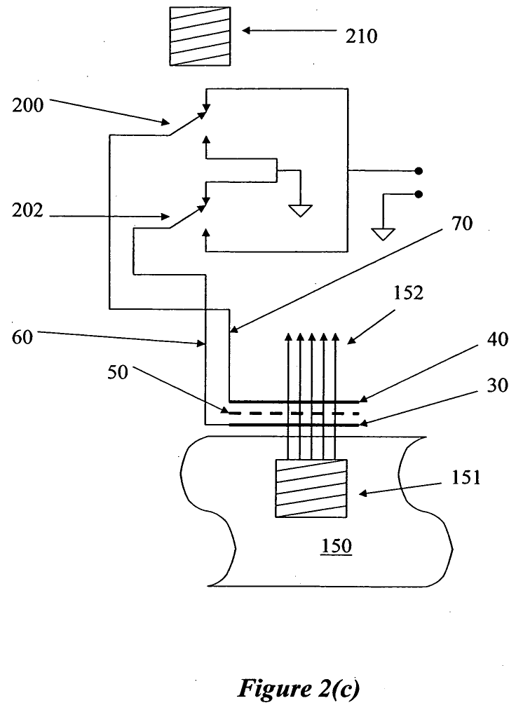

The malleable capacitive sensing device (described below) 10 shown in various aspects in FIGS. 1(a)-2(c) may advantageously be used, for example, in connection with hybrid ignition coils that operate the COP spark plug with a positive-going voltage and the companion spark plug with a negative-going voltage. FIGS. 1(a)-1(b) illustrate aspects of a malleable capacitive sensing device 10 useful in detecting electric near fields present proximate an electric field source such as, but not limited to, that generated by an ignition coil. Malleable capacitive sensing device 10 includes a sheet-like base 15 on which a plurality of capacitive signal detectors 20 are permanently or removably fixed on a front face thereof, of which two example configurations are depicted in FIGS. 1(a)-1(b). The permanent or removable fixation of the capacitive signal detectors 20 may be realized by any conventional method such as, but not limited to, bonding, snap connectors, or even Velcro®, the particular affixation method being guided, in part, by the capacitive signal detector's size. Capacitive signal detectors 20 may be formed using conventional methods (e.g., photolithographic etching or other conventional multi-layer forming processes) on the sheet-like base or on another flexible substrate or membrane that may in turn be attached or bonded to the sheet-like base 15, the particular methods of capacitive signal detector formation being guided in part by thermal considerations of the selected substrate material in a manner known to those skilled in the art of lithographic processes.

Capacitive signal detectors 20 may assume profiles other than that illustrated (e.g., hexagonal rather than square). Further, although the malleable capacitive sensing device 10 sheet-like base 15 shown as a circular body, the sheet-like base may assume any shape such as, but not limited to a square or rectangle, and may include one or more extensions (e.g., a circular shape with one or more rectangular extensions attached to or formed at an outer periphery thereof). Capacitive signal detectors 20 are formed from conductive members (e.g., plates, metallizations, or conductive layers) of any metal or material separated by a dielectric material, which may be a conventional common dielectric (e.g., glass, mica, green sheet, PC board) or more exotic dielectric materials (e.g., low-k dielectric, aerogel).

In accord with the present concepts, as few as one capacitive signal detector 20 could be provided on the sheet-like base 15, although a plurality of capacitors is generally desired. The capacitive signal detector(s) 20 could be positioned relative to the electric near field source (e.g., an ignition coil housing) by draping or placing the sheet-like base of the malleable capacitive sensing device 10 adjacent such electric near field source in such a manner as to position the capacitive signal detector(s) adjacent a known or suspected position of high electric field strength. If a plurality of capacitive signal detectors 20 are provided on or in the sheet-like base 15, they may be arranged in any pattern (e.g., an n×n or n×m array or matrix) or in a random arrangement. FIGS. 1(a)-1(b) depicts possible, non-limiting configurations of capacitive signal detector 20 placement.

The sheet-like base 15 comprises, in one aspect, a highly adaptable sheet which readily conforms to or drapes over any structure on which it is placed. This sheet-like base 15 may comprise a thin, conventional rubber material, a neoprene sheet, a silicone sheet, a woven or non-woven fabric or material (e.g., fiberglass fabric, fabrics comprising tough materials such as Kevlar or polyethylene polymers), or even a plurality of substantially inflexible materials connected by links or joints (e.g., inter-meshed chain-links which may optionally be disposed within a substantially continuous cover material). The sheet-like base 15 may be formed in a substantially flat shape, or may be pre-formed in a substantially curvilinear shape. It is merely sufficient that the sheet-like base 15 be able to substantially conform to at least a portion of the structure on which it is placed (e.g., an ignition coil housing or an external ignition coil wire) to permit disposition of one or more capacitive signal detectors 20 in an area of interest likely to possess or possessing a near electric field. An example of a malleable capacitive sensing device 10 in accord with the present concepts disposed or draped over an ignition coil housing 150 is shown in FIG. 2(a).

In another aspect, sheet-like base 15 comprises a state-changing fluid 16 such as, but not limited to a Theological fluid (e.g., an electrorheological or magnetorheological fluid), which changes state quickly, if not substantially instantly, upon application of an electric or magnetic field thereto. Thus, an electric or magnetic field may be applied to the sheet-like base 15 to cause a viscosity of such state-changing fluid 16 to change, thereby substantially affixing the sheet-like base relative to the structure upon which it is disposed.

As one example, a magneto-rheological fluid (a stable suspension of magnetically polarizable micron sized particles suspended in a low volatility carrier fluid such as a synthetic hydrocarbon) provides a high shear stress and a corresponding dramatic change in rheology in the bulk fluid upon application of a low applied magnetic field. Thus, the magneto-rheological fluid can change from being a fluid to a solid almost instantly upon application of such low applied magnetic field and can substantially instantly revert to its original fluid state upon removal of the field. In this way, as long as the field is maintained, the sheet-like base 15 can be removed from one structure (e.g., an ignition housing) and transferred to another structure (e.g., another ignition housing) for comparative testing. The low applied magnetic field may be generated by a coil solenoid winding disposed internally within, externally to, or on the sheet-like base 15 outer membrane or covering.

The present concepts include other state-changing fluids 16 which change viscosity or stiffness upon application of (or removal of) an electric or magnetic field, including the conventional appurtenant structures (e.g., electrical connections to provide a current through or voltage across a gel or a coil solenoid to apply a magnetic field) which permit such state changes to be realized. Once the sheet-like base 15 has been manipulated for best conformance to an ignition coil housing 150, the technician performs a switch closure (or disconnect) to initiate (or terminate) a field, current, or voltage to change the state-changing fluid from a first state to a second state, the second state being a state wherein the sheet-like base is less malleable than in the first state.

In still another aspect, shown by way of example in FIG. 1(d), the sheet-like base 15 back side can be provided with a plurality of lead ribbons 170 or one or more lead sheets to enable a technician to form the sheet-like base to at least partially conform to a surface or structure of interest. Since this configuration does not require the use of a state changing fluid 16, the plurality of lead ribbons 170 or one or more lead sheets could also be disposed internally within openings in an otherwise substantially solid sheet-like base. The thickness of the lead should have a thickness below about 0.0040″ and preferably between about 0.0015″-0.0020″. Deformation of the lead ribbons 170 or sheet permits the sheet-like base 15 bearing the capacitive signal detectors or sensors 20 to be placed adjacent the electric near field source (e.g., an ignition housing 150 during operation of the engine) to detect the electric near field emitted therefrom. The sheet-like base 15 may also be removed from one structure (e.g., an ignition coil housing 150) and transferred to another similarly configured structure (e.g., another adjacent ignition coil housing), without significantly affecting the geometry of the sheet-like base, to facilitate comparative testing. The lead ribbons or lead sheets 170 may be removably disposed within channels or openings formed in the sheet-like material so as to permit the lead ribbons or sheets to be removed and replaced, if necessary.

In a variation of this aspect, the sheet-like base 15 of the malleable capacitive sensing device 10 may include a mechanical fastener comprising one or more ties, snaps, ropes, clips, or Velcro® fittings or the like to permit a desired degree of securement and/or spacing between the capacitive signal detectors 20 and the electric near field source, which may include but is not limited to ignition coil housings. The sheet-like base 15 of the malleable capacitive sensing device 10 may also be affixed relative to an ignition coil housing simply by the properties of the selected material (e.g., elasticity, coefficient of friction, weight, etc.) and/or geometry of the selected material, and even by vacuum or pressure differentials (e.g., suction cups) or other conventional means of temporary securement.

As shown in FIGS. 2(b)-2(c), each capacitive signal detector or sensor 20 is electrically connected to two conductors 60, 70. In various aspects, conductors 60, 70 may comprise a multi-conductor mini-cable, wiring traces, and/or conductive vias.

The conductors 60, 70 and/or the capacitive signal detectors 20 may also comprise a conventional conductive rubber (e.g., an elastomer filled with carbon or metallic particles which render the material electrically conductive). In this aspect, stacked capacitive layers comprise thin layers of deposited conductive rubber with an insulation layer disposed therebetween. Interconnecting conductive members may also comprise a deposited conductive rubber to route signals to I/O connectors 136 (e.g., conductive bumps) disposed on the sheet-like member 15. In one aspect, the I/O connectors 136 may be advantageously disposed on the surface farthest from the ignition coil housing top surface. The I/O connectors 136 could comprise chip-on-board semiconductor mounted technology. During attachment of a sheet-like member 15 in accord with this aspect to an ignition coil housing 150, the capacitive plates 30, 40 could stretch, and possibly deform, losing their original shape and size, both absolutely and relatively (e.g., the upper plate with respect to the lower plate). Comparatively speaking, however, since it may be desired to only normalize a firing line signal output to an arbitrary equivalent (e.g., 10 KVp) from a first tested ignition coil (e.g., a COP ignition coil) encountered, and since the size and shape of each stacked capacitive plate pair 30, 40 would be about equal, not to each other, but to the same stacked pair in the same position in the matrix but on a different ignition coil housing, the results would be approximately equal for equal signal conditions. This could be interpreted, such as by a computer, based on the information stored from the first tested ignition coil. For example, the sweet spot or area of highest electric near field and the gain required in attempting to normalize the signal (or the difference in signal value at the same gain) for a first tested ignition coil could be used to facilitate identification of an associated sweet spot response for similarly configured ignition coil or ignition coil housing.

Conductors 60, 70 feed the signal directly to an attached I/O device(s) or electrical connector(s) 121, which in turn outputs the signals to computing and display devices. The I/O device 121 may comprise, for example, one or more digital short range RF transmitters (e.g., Bluetooth) or IR transmitters to the computing device and may further comprise a multiplexor controlled by the computing device and/or an amplifier.

A variety of other scanning and multiplexing designs are included within the present concepts, as would be apparent to one of ordinary skill in logic and circuit design. For example, the capacitive signal detectors 20 may each be connected to a bus and a word line for address control as in a conventional memory device, and may comprise corresponding logical devices such as a row address 130, row decoder 131, column address 132, and column decoder 133, as shown in FIG. 1(c). These logical devices are connected to an associated conventional I/O device 136 connected to the malleable capacitive sensing device 10 capacitive sensing device 20 circuit or circuits. The wireless I/O device 136 may be powered by via electrical connector 120, which may be connected, for example, to a shop power source, vehicular power source, or transformer, or locally by discrete power cells or batteries. In this aspect, the capacitive signal detectors 20 are selectively and sequentially enabled for a read operation and the output signal processed by a processing device 300, such as but not limited to a computer or processor bearing lab scope, comprising at least one processor 304 and compared to the signals of the remaining capacitive signal detectors to determine which capacitive signal detector(s) exhibit the highest reading. Alternatively, I/O device 136 may comprise a conventional hardwired electrical connector.

Once the above described malleable capacitive sensing device 10 is placed on a structure of interest, such as shown in FIG. 2(a), and the capacitive signal detector(s) 20 are substantially adjacent the location of the electric near field emitted by the structure of interest, such as an ignition coil housing 150 in the present example, the capacitive signal detectors 20 exhibiting the highest readings may be determined. In an embodiment wherein each of the capacitive signal detectors 20 is separately hardwired into a multiplexor, the switching and reading operations of all of the capacitive signal detectors would ideally be performed at a sufficient speed to resolve the firing line event (e.g., the Nyquist interval) of the secondary ignition coil waveform for each of the capacitive signal detectors. Due to the periodicity of the ignition event, a selective sampling of selected groupings of capacitive signal detectors 20 may also be implemented at lower sampling rates and the results aggregated to identify the capacitive signal detectors 20 exhibiting the highest readings during the firing line event or other event of interest.

As shown in FIG. 2(c), a dual DPDT solid state solenoid 210 actuated switch 200 can be used to maximize attenuation and minimize boost by grounding via switch 201 the conductive member closest to the ignition coil housing 150 (i.e., upper conductive members 30) and connecting via switch 202 the conductive member furthest from the ignition coil housing (i.e., lower conductive members 40) exhibiting the highest firing line to the signal output, omitting connection of any adjacent capacitive signal detectors in a like manner.

Minimum attenuation and maximum boost may be introduced by grounding, via switch 201, the conductive members farthest from the ignition coil housing (i.e., lower conductive members 40) and connecting, via switch 202, the conductive members closest to the ignition coil housing (i.e., upper conductive members 30). Further, a plurality (e.g., 2, 3, 4, 8 or more) of the conductive members closest to the ignition coil housing (i.e., upper conductive members 30) in parallel so as to effectively increase the signal detection area.

Combinations of simultaneous attenuation and boost may be selected by the computing device 300 for better resolution and thereby fine-tuning the output level to a firing line equivalent to a selected value. In one aspect, it is desirable to fine-tune the output level to a firing line equivalent as close to about 10KVp as possible. A 10KVp firing line voltage is not a technical limitation, but rather a readily accepted value to which technicians in the industry are accustomed.

Analog or digital devices and electrical connectors may be advantageously mounted on the surface of the sheet-like base 15, such as on a backside of the sheet-like base. These components may be mounted on or integrated into an outer periphery of the sheet-like base or an extension thereof, as illustrated in FIGS. 1(a)-(b), for example. Alternately, the sheet-like base 15 could provide electrical connectors or I/O devices to output the signals from the capacitive signal detectors 20 to external devices or receivers.

The output signals from the malleable capacitive sensing device 10 may be optionally input into a signal processor 300, which may comprise an amplifier, to extract or to emphasize any portion(s) of the output signals (e.g., the most common types of needed information, which could include burn time, firing line and spark line). The raw signals or waveforms output from the malleable capacitive sensing device 10, or the conditioned signals or waveforms, are preferably output to a processing device 300. The processing device 300 could include or be electrically connected to a display device 312 that simply shows the waveform or signal emanating from the malleable capacitive sensing device 10 or from the signal processor 300. Processing device 300 could provide numerical values for some or all of the important parameters, or other visual or tonal representations thereof, such as burn time, firing line and spark line. Processing device 300 may comprise at least one display device 312 (e.g., a high impedance scope), printing device 324, communication device 318 (e.g., serial or parallel output port, phone line, IR, RC, or wireless communication), and an electronic storage device 310 (e.g., hard drive, CD-ROM, removable port memory device, etc.).

Processing device 300 may comprise a computer or any conventional engine analyzer, lab scope, ignition scope, or display, such as but not limited to a Snap-On® MODIS®, available from Snap-On® Diagnostics of San Jose, Calif., useful in conjunction with malleable capacitive sensing device 10.

In accord with the above aspects, the output of each ignition coil may be viewed, one at a time, on a processing device 300 display 312, such as a high input impedance scope.

The malleable capacitive sensing device 10 may also be ganged together with other malleable capacitive sensors to permit simultaneous testing of multiple ignition coils or multiple electric near field sources of any type. Multiple discrete malleable capacitive sensing devices 10 may also be disposed in combination to permit simultaneous testing of multiple ignition coils or multiple electric near field sources of any type.

In accord with the above disclosure, a method for detecting an electric near field present proximate an ignition coil housing 150, may comprise the step of draping a capacitive sensing device 10 comprising a flexible base sheet 15 and at least one capacitive sensor 20 arranged on a surface thereof over an ignition coil housing with the at least one capacitive sensor disposed adjacent the ignition coil housing. Subsequently, the method would include a step of securing the at least one capacitive sensor 20 adjacent the ignition coil housing 150, and outputting from the capacitive sensor a signal representative of an electric near field (represented by arrowsl52) generated by the ignition coil 151 in the ignition coil housing.

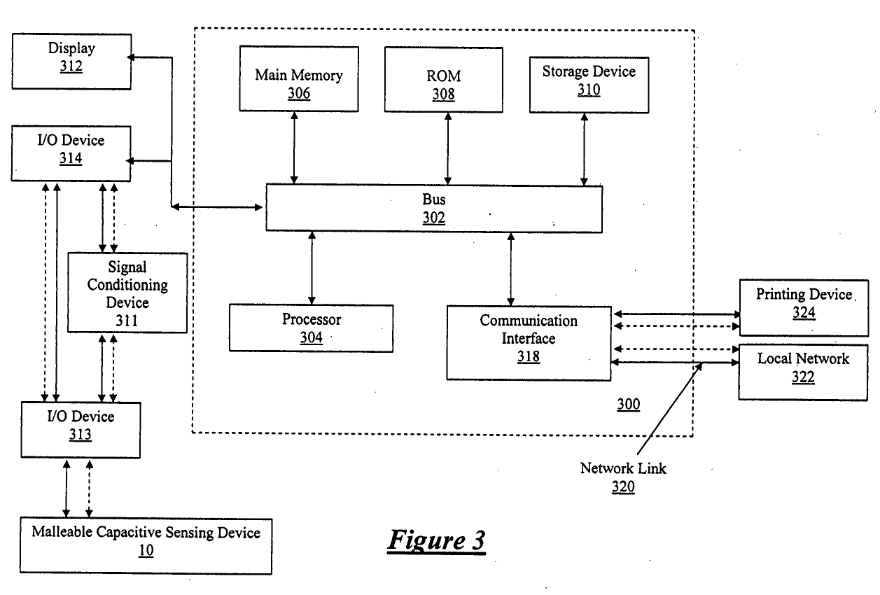

The method for detecting an electric near field 152 present proximate an ignition coil housing 150 may further comprise the steps of outputting a signal from the at least one capacitive sensor 20 to a processing device 300 comprising a processor 304 and a display device 312, a printing device 324, communication device 318, and/or an electronic storage device 310. As shown in FIG. 3 and as described above, the outputting of the signal from the capacitive sensing device 10 may be by a hardwired or a wireless connection, such as is respectively denoted by the solid and dashed arrows between the capacitive sensing device, I/O device 313, signal conditioning device 311 and I/O device 314. The method may further comprise the step of processing a signal output by the at least one capacitive sensor using a signal conditioning device 311, which may comprise, for example, a signal processor and/or an amplifier. The method for detecting an electric near field present proximate an ignition coil housing may further include the step of securing the capacitive sensor 20 adjacent the ignition coil housing 150 by applying an electric field and/or a magnetic field to a state-changing gel (e.g., 16, FIG. 1(e)) disposed within the capacitive sensing device 10 flexible base sheet 15 to change a state of the state-changing gel from a first state to a second state, the second state being more viscous than the first state.

Embodiments described herein or otherwise in accord with the concepts presened herein may include or be utilized with any appropriate voltage source, such as a battery, an alternator and the like, providing any appropriate voltage such as, but not limited to, about 9 Volts, about 12 Volts, about 14 Volts, about 42 Volts and the like.

The embodiments described herein may be used with any desired system or engine. Those systems or engines may comprise items utilizing fossil fuels, such as gasoline, natural gas, propane and the like; non-fossil fuels, such as hydrogen or ethanol; electricity, such as that generated by battery, magneto, solar cell and the like; wind and hybrids; or combinations of the above. Those systems or engines may be incorporated into other systems, such as an automobile, a truck, a boat or ship, a motorcycle, a generator, an airplane and the like.

1. A capacitive sensing device comprising:
a flexible base sheet; and
a plurality of capacitive sensors arranged on an exterior surface of the flexible base sheet, each capacitive sensor comprising a top conductor layer, a middle dielectric layer, and a bottom conductive layer, each of the top conductor layer and bottom conductive layer having an electrical lead connected thereto.

2. A capacitive sensing device according to claim 1, wherein the plurality of capacitive sensors comprises an array of capacitive sensors.

3. A capacitive sensing device according to claim 1, wherein the flexible base sheet comprises at least one of a woven fabric, non-woven fabric, a rubber material, and a plurality of substantially inflexible materials connected by joints.

4. A capacitive sensing device according to any one of claims 1 to 3, wherein the flexible base sheet comprises a gel encased within a covering.

5. A capacitive sensing device according to claim 4, further comprising:
an electrical lead connecting a power source to at least one of the flexible base sheet gel and a magnetic field generator disposed proximal to or within the capacitive sensing device,
wherein the gel comprises a state-changing gel adapted to change from a first state to a second state upon at least one of application and removal of at least one of an electric and a magnetic field.

6. A capacitive sensing device according to claim 5, wherein the gel first state is less viscous that the gel second state.

7. A capacitive sensing device according to claim 6, wherein the gel comprises a rheological fluid.

8. A capacitive sensing device according to any one of claims 1 to 3, wherein the flexible base sheet includes a mechanical fastener comprising at least one of a lead ribbon, lead sheet, tie, snap, rope, cord, cable, clip, and Velcro® fitting to facilitate disposition of the capacitive sensing device adjacent an electric near field source.

9. A diagnostic system for analyzing the operation of an internal combustion engine, the diagnostic system comprising:
a capacitive sensing device comprising a flexible base sheet and a plurality of capacitive sensors arranged on an exterior surface thereof, each capacitive sensor comprising a top conductor layer, a middle dielectric layer, and a bottom conductive layer, each of the top conductor layer and bottom conductive layer having an electrical lead connected thereto.

10. A diagnostic system for analyzing the operation of an internal combustion engine according to claim 9, the diagnostic system further comprising a processing device.

11. A diagnostic system for analyzing the operation of an internal combustion engine according to claim 10, the diagnostic system further comprising a signal processor.

12. A diagnostic system for analyzing the operation of an internal combustion engine according to claim 10, wherein the processing device comprises a processor and at least one of a display device, a printing device, a communication device, and an electronic storage device.

13. A diagnostic system for analyzing the operation of an internal combustion engine according to claim 12,
wherein the plurality of capacitive sensors comprises an array of capacitive sensors, and
wherein the flexible base sheet comprises at least one of a woven fabric, non-woven fabric, a rubber material, and a plurality of substantially inflexible materials connected by joints.

14. A diagnostic system for analyzing the operation of an internal combustion engine according to claim 13,
wherein the flexible base sheet comprises a gel encased within a covering,
wherein the capacitive sensing device comprises an electrical lead connecting a power source to at least one of the flexible base sheet gel and a magnetic field generator disposed proximal to or within the capacitive sensing device, and
wherein the gel comprises a state-changing gel adapted to change from a first state to a second state upon at least one of application and removal of at least one of an electric and a magnetic field.

15. A diagnostic system for analyzing the operation of an internal combustion engine according to claim 14, wherein the gel first state is less viscous that the gel second state.

16. A diagnostic system for analyzing the operation of an internal combustion engine according to claim 15, wherein the gel comprises a rheological fluid.

17. A method for detecting an electric near field present proximate an ignition coil housing, comprising the steps of:
draping a capacitive sensing device comprising a flexible base sheet and at least one capacitive sensor arranged on a surface thereof over an ignition coil housing with the at least one capacitive sensor disposed adjacent the ignition coil housing;
securing the at least one capacitive sensor adjacent the ignition coil housing; and
outputting from the at least one capacitive sensor a signal representative of an electric near field generated by the ignition coil in the ignition coil housing.

18. A method for detecting an electric near field present proximate an ignition coil housing according to claim 17, further comprising the step of:
reporting a signal output by the at least one capacitive sensor to a processing device comprising a processor and at least one of a display device, a printing device, communication device, and an electronic storage device.

19. A method for detecting an electric near field present proximate an ignition coil housing according to claim 17, further comprising the step of:
processing a signal output by the at least one capacitive sensor using at least one of a signal processor and amplifier.

20. A method for detecting an electric near field present proximate an ignition coil housing according to claim 18, wherein the step of securing the at least one capacitive sensor adjacent the ignition coil housing comprises the step of:
applying at least one of an electric field and a magnetic field to a state-changing gel disposed within the capacitive sensing device flexible base sheet to change a state of the state-changing gel from a first state to a second state, the second state being more viscous than the first state.
